(19) United States
(12) Patent Application Publication
(10) Pub. No.: US 2025/0014017 A1
(43) Pub. Date: Jan. 9, 2025

(54) SYSTEMS AND METHODS OF LOCATION-BASED CHECK-IN AND ASSISTANCE USING A CONTACTLESS CARD

(71) Applicant: Capital One Services, LLC, McLean, VA (US)

(72) Inventors: Jennifer VALENTI, Reston, VA (US); Kevin WIDENER, Midlothian, VA (US); Anita ERADLA, Ashburn, VA (US); Kimberly HAYNES, Reston, VA (US)

(21) Appl. No.: 18/218,500

(22) Filed: Jul. 5, 2023

(51) Int. Cl. G06Q 20/34

(52) U.S. Cl. CPC G06Q 20/352

(57) ABSTRACT

A method for location-based check-in and assistance based on a contactless card is provided including: receiving, by a server from a first device, a first cryptogram of the contactless card; determining, by the server, a location of the first device based on the first cryptogram; transmitting, by the server to a user device, a notification requesting tapping the contactless card to the user device; receiving, by the server from the user device, a second cryptogram of the contactless card; authenticating, by the server, a user of the user device based on the second cryptogram, the user being associated with the contactless card; verifying, by the server, the user of the user device to be at the location based on the authentication; and notifying, by the server, a user of a second device that the user of the user device is at the location and is requesting assistance.

### FIELD OF THE INVENTION

The present disclosure relates generally to card technology, and more particularly, to systems and methods for location-based check-in and assistance using a contactless card.

### BACKGROUND

Merchants interact with many customers daily. Some customers prefer no physical contact when doing business. For example, in view of the recent pandemic, customers may seek safer, contactless, more efficient ways of interacting with merchants. Also, long wait times can contribute to decline in customer satisfaction and loyalty.

Additionally, when customers need to verify their identity, they may be required to hand a government identification card (ID) to business employees, which can lead to increased opportunities to transmit diseases, and thus may create increased brand, reputation, and legal risks for merchants.

Further, when customers need assistance, the customer may need to track down a an employee of the merchant. Requiring a customer in need of assistance to find an employee may result in the customer not receiving timely assistance or not receiving assistance at all, which puts the merchant at risk of losing the customer or missing an opportunity to acquire further customers.

These and other deficiencies exist. Accordingly, there is a need to provide systems and methods that overcome these deficiencies to facilitate customers and enhance customer experiences, such as location-based check-in and assistance using a contactless card.

### SUMMARY

Aspects of the disclosed technology include systems and methods of location-based check-in and assistance based on a contactless card.

Embodiments of the present disclosure provide a method for location-based check-in and assistance based on a contactless card, including: receiving, by a server from a first device, a first cryptogram of the contactless card; determining, by the server, a location of the first device based on the first cryptogram; transmitting, by the server to a user device, a notification requesting tapping the contactless card to the user device; receiving, by the server from the user device, a second cryptogram of the contactless card; authenticating, by the server, a user of the user device based on the second cryptogram, the user being associated with the contactless card; verifying, by the server, the user of the user device to be at the location based on the authentication; and notifying, by the server, a user of a second device that the user of the user device is at the location and is requesting assistance.

Embodiments of the present disclosure provide a system for location-based check-in and assistance based on a contactless card. The system includes a server. The server can be configured to: receive, from a first device, a first cryptogram of the contactless card; determine a location of the first device based on the first cryptogram; transmit, to a user device, a notification requesting tapping the contactless card to the user device; receive, from the user device, a second cryptogram of the contactless card; authenticate, a user of the user device based on the second cryptogram, the user being associated with the contactless card; verify the user of the user device to be at the location based on the authentication; and notify a user of a second device that the user of the user device is at the location and is requesting assistance.

Embodiments of the present disclosure provide a non-transitory, computer-readable medium comprising instructions for location-based check-in and assistance based on a contactless card that, when executed on a computer arrangement, perform actions including: receiving, from a first device, a first cryptogram of the contactless card; determining a location of the first device based on the first cryptogram; transmitting, to a user device, a notification requesting tapping the contactless card to the user device; receiving, from the user device, a second cryptogram of the contactless card; authenticating, a user of the user device based on the second cryptogram, the user being associated with the contactless card; verifying the user of the user device to be at the location based on the authentication; and notifying a user of a second device that the user of the user device is at the location and is requesting assistance.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for location-based check-in and assistance using a contactless card according to an example embodiment.

FIG. 2 is a sequence diagram of interactions between components of the system in FIG. 1 according to an example embodiment.

FIG. 3 is a contactless card used for location-based check-in and assistance according to an example embodiment.

FIG. 4 is a diagram of the contact pad of the contactless card in FIG. 3 according to an example embodiment.

FIG. 5 is a flow chart of a method for location-based check-in and assistance using a contactless card according to an example embodiment.

FIG. 6 is a flow chart of a method for location-based check-in and assistance using a contactless card according to an example embodiment.

### DETAILED DESCRIPTION OF EXAMPLE EMBODIMENTS

The following description of example embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the example embodiments may be combined in any suitable manner. One skilled in the relevant art will recognize that the embodiments may be practiced without one or more of the specific described features and teachings of an embodiment. In other instances, additional described features and teachings may be recognized in certain embodiments that may not be present in all embodiments. One skilled in the relevant art will understand that the described features and teachings of any embodiment can be interchangeably combined with the features, advantages, and characteristics of any other embodiment.

Merchants, e.g., banks and other businesses, either through employees or self-service kiosks, need to check in customers, and this requires additional identity verification, such as manually presenting a physical ID. Additionally, these processes do not create a contactless experience and do not provide geo-based information back to the merchants. In the present disclosure, contactless interactions and authentications can improve customers experiences. Example embodiments of the present disclosure provide systems and methods for location-based check-in and assistance using a contactless card. The present disclosure can use a contactless card platform to enable contactless check-in location determination and customer authentication.

The present disclosure can enable in-person near field communication (NFC) authentication for check-in and geo-based assistance utilizing a contactless card technology and the geo-location features of a customer's mobile phone. For example, a customer can arrive at a merchant's branch or other location, tap his/her contactless card to a self-service kiosk, which will initiate a push notification to his/her mobile device (e.g., a phone). Then the customer can open the push notification and tape his/her contactless card to his/her mobile device, which will alert employees to the customer's check-in and request for geo-location assistance in the branch or other location. The customer can be free to browse the branch or other location and find a space away from other customers.

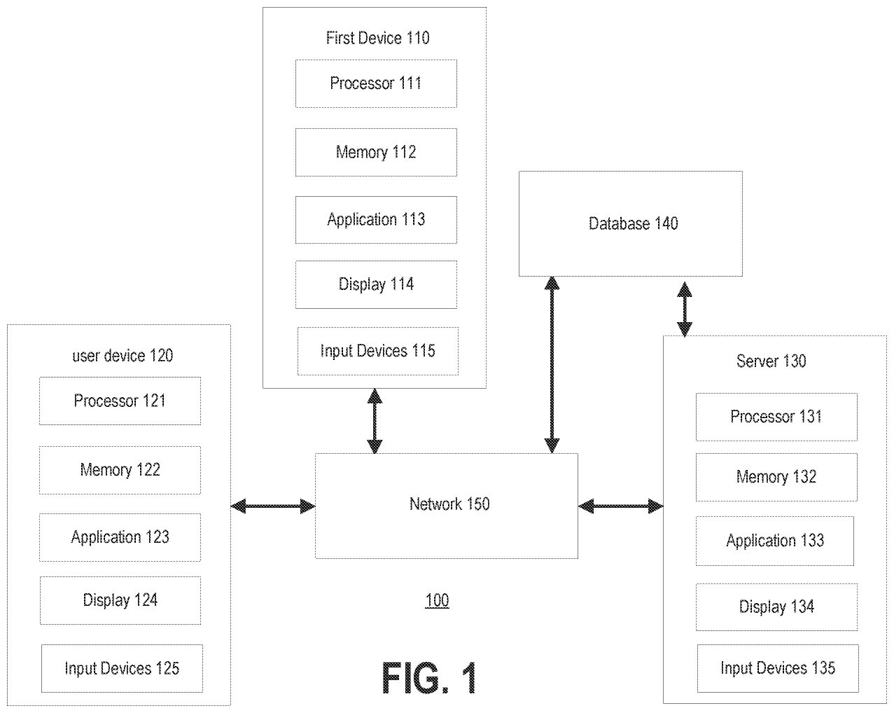

FIG. 1 illustrates a system 100 for location-based check-in and assistance using a contactless card according to an example embodiment. As further discussed below, the system 100 may include a first device 110, a user device 120, a server 130, a database 140 in communication using a network 150, and a contactless card 160 in signal communication with the first device 110 and the user device 120. Although FIG. 1 illustrates single instances of the components, the system 100 may include any number of components.

The first device 110 may be associated with a bank or a customer service center. The first device 110 can be configured to store customer information, and to present an interaction interface on which a customer can conduct interactions with the brank or customer service center.

The first device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The first device 110 may include a processor 111, a memory 112, and an application 113. The processor 111 may be a processor, a microprocessor, or other processor, and the first device 110 may include one or more of these processors. The processor 111 may include processing circuitry, which may contain additional components, including additional processors, memories, error and parity and/or CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the first device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's shopping and financial account information.

The application 113 may comprise one or more software applications comprising instructions for execution on the first device 110. In some examples, the first device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. For example, the application 113 may be executed to perform determining a check-in location for a customer by working with the server 130. Such processes may be implemented in software, such as software modules, for execution by computers or other machines. The application 113 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The first device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the first device 110 that is available and supported by the first device 110, such as a touch-screen, keyboard, mouse, cursor-control device, touch-screen, microphone, digital camera, video recorder or camcorder. These devices may be used to enter information and interact with the software and other devices described herein.

The user device 120 can be used by a user to initiate and/or perform transactions/interactions with the first device 110. The user device 120 may be configured to present to the user a user interface from which the user may log into, for example, their bank or credit card account to access their transaction statement and/or financial information stored in the database 140 of the server 130. The user interface may also be configured to perform data communication with the contactless card 160. The user device 120 may be configured to display on the user interface a branch's website, in response to a selection by the user of accessing the branch's website.

The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, an application 123, a display 124, and input devices 125. The processor 121 may be a processor, a microprocessor, or other processor, and the user device 120 may include one or more of these processors. The processor 121 may include processing circuitry, which may contain additional components, including additional processors, memories, error and parity and/or CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the user device 120. In some examples, the user device 120 may execute one or more applications, such as software applications, that enable, for example, network communications with one or more components of the system 100, transmit and/or receive data, and perform the functions described herein such as presenting the online website to the user of the user device 120 and reading the contactless card 160. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein such as selecting an option of creating an online account with the branch.

The server 130 may be associated with an institution, such as a financial institution or a bank, and can be configured to communicate with the first device 110 and the user device 120. The institution associated with the server 130 may issue the contactless card 160 to the user and accordingly may authenticate the user based on the contactless card 160.

The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the card authentication module of the application 133 may be executed to perform authenticating the user based on the contactless card 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

The database 140 may be one or more databases configured to store date, including without limitation, private information of users, financial accounts of users, contactless card information, online branch account information, transactions of users, and branch records indicative of corresponding branches. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the first device 110, the user device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the first device 110, server 130, and user device 120 using the network 150 can occur using one or more front channels and one or more secure back channels. A front channel may be a communication protocol that employs a publicly accessible and/or unsecured communication channel such that a communication sent to the first device 110, server 130, and/or user device 120 may originate from any other device, whether known or unknown to the first device 110, server 130, and/or user device 120, if that device possesses the address (e.g., network address, Internet Protocol (IP) address) of the first device 110, server 130, and/or user device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the first device 110, server 130, and/or user device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

The contactless card 160 may be any type of card, such as a security card, a payment card, an identification card, and the like. The contactless card 160 may be issued to the user by the financial institution for identity verification for the bank account of the user.

The contactless card 160 can be configured to transmit a cryptogram to the user device 120 upon tapping to the user device 120. The user device 120 may be configured to read the cryptogram from the contactless card 160 after entry of the contactless card 160 into a communication field of the user device 120. The user device 120 may then transmit the cryptogram to the server 130. The server 130 may be configured to verify the cryptogram by searching the database 140.

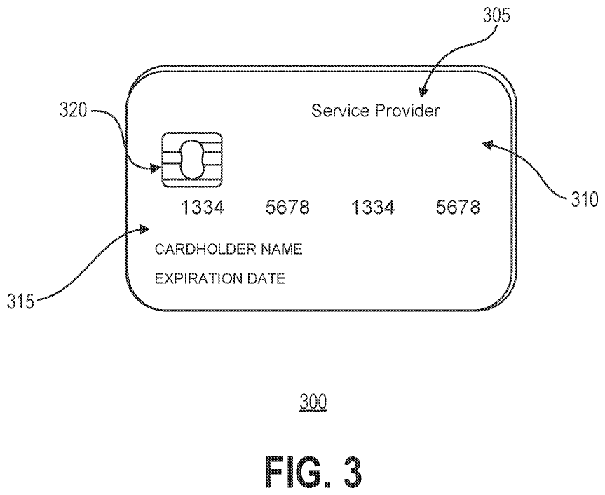

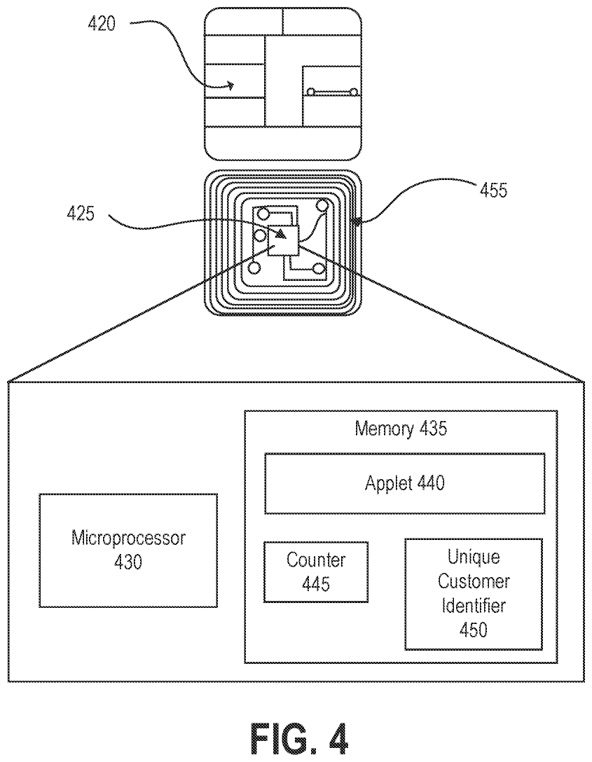

The contactless card 160 can perform authentication and numerous other functions that may otherwise require a user to carry a separate physical token in addition to the contactless card 160. By employing a contactless interface, the contactless card 160 may be provided with a method to interact and communicate between a user's device (such as a mobile phone or the user device 120) and the card itself. For example, the Europay, Mastercard, and Visa (EMV) protocol, which underlies many credit card transactions, includes an authentication process which suffices for operating systems for Android® but presents challenges for iOS®, which is more restrictive regarding near field communication (NFC) usage, as it can be used only in a read-only manner. Exemplary embodiments of the contactless card 160 described herein utilize NFC technology. The contactless card 160 may comprise a substrate 162 and a contact pad 164. Details of an example contactless card will be described in FIGS. 3 and 4.

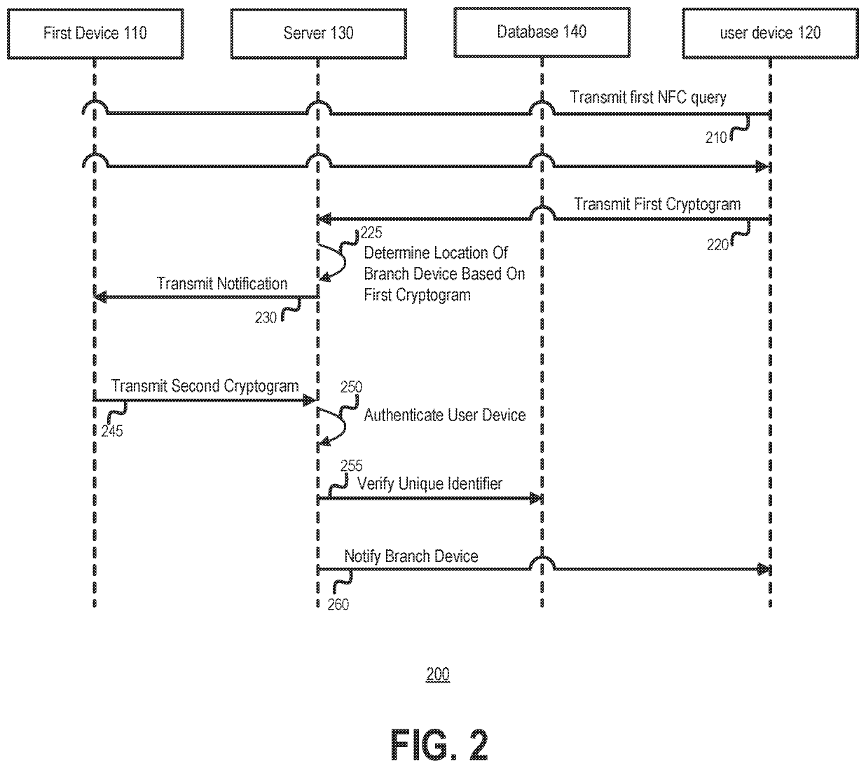

FIG. 2 illustrates an example diagram 200 of sequence interactions between the components of the system 100 according to an example embodiment. FIG. 2 may reference the same or similar components as those illustrated in FIG. 1, including a first device, a user device, a server, a database, and a contactless card.

When a user wants to conduct businesses with a bank or a customer service center, for example, depositing a check at a bank branch or returning a product at a customer service front desk, the user may walk into the bank branch. To check in, the user may use a contactless card (e.g., the contactless card 160) and a first device (e.g., the first device 110) such as a self-service kiosk at the bank branch. The first device 110 is a NFC-enabled device, and may include an NFC interface configured for establishing an NFC communication with other NFC-equipped devices (e.g., the contactless card 160). In some of these embodiments, the NFC interface of the first device 110 may be or include an NFC receiver configured for selectively activating a magnetic field for use in establishing near field communication with an NFC transmitter. The NFC interface of the first device 110 is configured for establishing NFC communication when a passive NFC tag or other NFC-enabled device is brought into the magnetic field and within the NFC communication range of the first device 110. The NFC interface of the first device 110 is configured, in particular, for communication with the NFC-enabled card 160 when the card 160 is brought within communication range of the first device (such as, the contactless card 160 is tapped by the user to the first device 110). As used herein, a tap of the contactless card 160 to the first device 110 may not indicate that the contactless card 160 is in a physical contact with the first device 110. A tap of the contactless card 160 to the first device 110 may refer to entry of the contactless card 160 into the NFC communication field of the first device 110. The contactless card 160 is also a NFC-enabled card. At step 210, the first device 110 may transmit a first NFC query to the contactless card 160.

In response, after entry of the contactless card 160 into the NFC communication field of the first device, the contactless card 160 transmits, at step 215 to the first device 110 NFC response information (e.g., a first cryptogram) usable by the server 130 to authenticate the contactless card 160. The NFC response information may be or include, for example, security information encrypted by the contactless card 160 using a private key unique to the contactless card 160 that is known only to the card account administrator (e.g., the server 130). The first cryptogram may be stored in the memory of the contactless card 160. The first cryptogram includes an unique identifier of the contactless card 160.

At step 220, the first device 110 transmits the first cryptogram to the server 130. At step 225, the server 130 receives the first cryptogram from the first device 110. The server 130 validates the first cryptogram, decrypts the first cryptogram and extracts the unique identifier of the contactless card 160 through the card authentication module of the server 130. When the server 130 receives the first cryptogram, the server 130 may decrypt the cryptogram before or after verifying the first cryptogram. The server 130 may then extract the unique identifier of the contactless card 160 which is uniquely associated with the contactless card 160. The server 130 then determines the location of the first device 110 based on the first cryptogram. The server 130 and/or the first device 110 may then notify employees at the bank branch that a customer has checked in using the contactless card 160. In this way, the bank employees know the user has arrived at the bank branch, that is, the user's location is known without physical contact/interaction with the bank employees.

The tap of the contactless card 160 on the first device 110 would notify the branch employees that the user is now at that specific branch location. However, the user may need to be further authenticated, that is, along with the geographical location of the bank branch, the user may be authenticated to insure that the user is who you say you are and you are where you say you are. For example, to authenticate the user, it may require the user to demonstrate that his/her mobile phone (e.g., the user device 120) and the contactless card 160 are in the same place (e.g., the branch location as determined above). At step 230, the server 130 may access the database 140 to retrieve data of the user device 120 and transmit a notification to the user device 120 to ask the user to tap the contactless card 160 on the user device 120. The notification may be a short message service (SMS) message. The SMS message may contain a universal link (e.g., a deep link or application clip). The universal link in the SMS message may then open up a mobile application or mobile application process on the user device 120 from which the contactless card 160 can be read in that mobile application. If the mobile application is not already installed on the user device 120, the link may trigger a download activation to download the mobile application and install it on the user device 120. The user may use the user device 120 to transmit an NFC prompt and/or query to the contactless card 160 at step 235. The user device 120 may include an NFC interface configured for establishing an NFC communication with other NFC-equipped devices (e.g., the contactless card 160). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the contactless card 160 transmits, at step 240 to the user device 120 NFC response information (e.g., a second cryptogram) usable by the server 130 to authenticate the user and/or contactless card 160. The NFC response information may be or include, for example, security information encrypted by the contactless card 160 using a private key unique to the card that is known only to the card account administrator (e.g., the server 130). The second cryptogram may be stored in the memory of the contactless card 160. The second cryptogram includes the unique identifier of the contactless card 160.

At step 245, the user device 120 transmits the NFC response information (the second cryptogram) to the server 130. At step 250, the server 130 receives the second cryptogram from the user device 120. The server 130 validates the second cryptogram, decrypts the second cryptogram and extracts the unique identifier of the contactless card 160 through the card authentication module of the server 130. When the server 130 receives the second cryptogram, the server 130 may decrypt the second cryptogram before or after verifying the second cryptogram. The server 130 may then extract the unique identifier of the contactless card 160 which is uniquely associated with the user. At step 255, the server 130 may verify the unique identifier of the contactless card 160 by searching the database 140. The user can be authenticated based on the unique identifier.

At step 260, the server 130 may notify the bank employees through the first device 110 that the user has been authenticated. For example, the server 130 may transmit a SMS message including the user's success authentication information to the bank employees via the first device 110 and/or other bank first devices. In this way, the user can be authenticated without contact/interactions with the bank employees, so no physical government ID of the user is required to exchange between the user and the bank employees for authenticating the user. In some embodiments, the link with a deep link may be transmitted into the mobile application of the user device 120, and the user can follow the link to tap the contactless card 160. In such scenarios, the user does not have to fully log in the mobile application installed on the user device 120. The user just taps the contactless card 160 to the user device 120 and the server 130 verifies the user using the contactless card 160.

FIG. 3 describes a contactless card 300 that can be used for determining the bank branch location and authenticating the user in the system 100 of FIG. 1. The contactless card 160 in FIG. 1 can be the contactless card 300 described herein. The contactless card 300 is configured to communicate with the first device 110 and the user device 120 of the system 100. The contactless card 300 may comprise a payment card, such as a credit card, debit card, or gift card, issued by a service provider 305 (such as a bank associated with the server 130) displayed on the front or back of the contactless card 300. In some examples, the contactless card 300 is not related to a payment card, and may comprise, without limitation, an identification card, a membership card, and a transportation card. In some examples, the contactless card 300 may comprise a dual interface contactless payment card.

The contactless card 300 may comprise a substrate 310, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the ISO/IEC 7810 standard, and the contactless card 300 may otherwise be compliant with the ISO/IEC 14443 standard. However, it is understood that the contactless card 300 according to the present disclosure may have different characteristics, and the present disclosure does not require the contactless card 300 to be implemented in a payment card.

The contactless card 300 may also include identification information 315 displayed on the front and/or back of the contactless card 300, and a contact pad 320. The contact pad 320 may be configured to establish contact with another communication device, such as a user device, smart phone, laptop, desktop, or tablet computer. The contactless card 300 may also include processing circuitry, antenna and other components. These components may be located behind the contact pad 320 or elsewhere on the substrate. The contactless card 300 may also include a magnetic strip or tape, which may be located on the back of the contactless card 300.

FIG. 4 illustrates an example contact pad 320 of the contactless card 300. In FIG. 4, the contact pad 320 is referred to as a contact pad 420. The contact pad 420 of the contactless card may include processing circuitry 425 for storing and processing information, including a processor 430 and a memory 435. It is understood that the processing circuitry 425 may contain additional components, including processors, memories, error and parity and/or CRC checkers, data encoders, anticollision algorithms, controllers, command decoders, security primitives and tamperproofing hardware, as necessary to perform the functions described herein.

The memory 435 may be a read-only memory, write-once read-multiple memory or read/write memory, e.g., RAM, ROM, and EEPROM, and the contactless card may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

In some embodiments, the memory 435 may also have stored public and private card encryption keys. In some embodiments, the private and public encryption keys may be permanently hard-wired into the card memory 435. In various embodiments, the memory 435 may have stored therein instructions for generating encrypted information and transmitting it to a receiving device (e.g., the user device 120). Such encrypted information may be or include an encrypted verification block or signature that may be used to authenticate and verify the presence of the contactless card during transaction processing. In some embodiments, encrypted information may be unique to a particular communication (e.g., a particular NFC transmission by the contactless card).

The memory 435 may be configured to store one or more applets 440, one or more counters 445, and a unique customer identifier 450. The one or more applets 440 may comprise one or more software applications configured to execute on one or more contactless cards, such as Java Card applet. However, it is understood that the one or more applets 440 are not limited to Java Card applets, and instead may be any software application operable on contactless cards or other devices having limited memory. The one or more counters 445 may comprise a numeric counter sufficient to store an integer. The unique customer identifier 450 may comprise a unique alphanumeric identifier assigned to a user of the contactless card, and the identifier may distinguish the user of the contactless card from other contactless card users. In some examples, the customer identifier 450 may identify both a customer and an account assigned to that customer and may further identify the contactless card associated with the customer's account.

The processor 430 and memory 435 elements of the foregoing exemplary embodiments are described with reference to the contact pad 420, but the present disclosure is not limited thereto. It is understood that these elements may be implemented outside of the contact pad 420 or entirely separate from it, or as further elements in addition to the processor 430 and the memory 435 elements located within the contact pad 420.

In some examples, the contactless card may comprise one or more antennas 455. The one or more antennas 455 may be placed within the contactless card and around the processing circuitry 425 of the contact pad 420. For example, the one or more antennas 455 may be integral with the processing circuitry 425 and the one or more antennas 455 may be used with an external booster coil. As another example, the one or more antennas 455 may be external to the contact pad 420 and the processing circuitry 425.

In an embodiment, the coil of contactless card may act as the secondary of an air core transformer. A terminal (such as the first device 110 and the user device 120) may communicate with the contactless card by cutting power or amplitude modulation. The contactless card may infer the data transmitted from the terminal using the gaps in the contactless card's power connection, which may be functionally maintained through one or more capacitors. The contactless card may communicate back by switching a load on the contactless card's coil or load modulation. Load modulation may be detected in the terminal's coil through interference.

As explained above, the contactless card may be built on a software platform operable on smart cards or other devices having limited memory, such as JavaCard, and one or more or more applications or applets (applet 440) may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader (the user device 120), and produce an NDEF message that comprises a cryptographically secure OTP encoded as an NDEF text tag.

The contactless card may be configured for communication with the first device 110 and the user device 120 via a communication interface configured for establishing communication with the first device 110 and the user device 120. The communication interface may be configured for contact-based communication, in which case the interface may have electrical circuitry and contact pads on the surface of the contactless card for establishing direct electrical communication between the contactless card and the first device 110 and the user device 120. Alternatively or in addition, the communication interface may be configured for contactless communication with the first device 110 and the user device 120. In such embodiments, the communication interface may be or include an NFC communication interface configured for communication with other NFC communication devices when the contactless card is within a predetermined NFC range. In some embodiments, the contactless card may include a second communication interface configured for establishing short range communication with the first device 110 and the user device 120 via Bluetooth, or other short range communication methodology. In such embodiments, the contactless card may have a short range communication antenna that is included in or connected to the short range communication interface. The contactless card may also include a power management system for use in managing the distribution of power during an NFC transaction.

The contactless card 300 can be configured to transmit a cryptogram to the first device 110 or the user device 120 upon tapping to the first device 110 or the user device 120. The first device 110 or user device 120 may be configured to read the cryptogram from the contactless card 300 after entry of the contactless card 300 into a communication field of the first device 110 or user device 120. The first device 110 or user device 120 may then transmit the cryptogram to the server 130. The server 130 may be configured to verify the cryptogram by searching the database 140.

In some embodiments, the cryptogram can be generated by the contactless card 300 as follows. When receiving a request for authentication, the counter 445 can increment counter. The applet 440 upon execution by the processor 430 can generate two session keys (e.g., one for encryption (ENC) and one for message authentication code (MAC)) using secret keys combined with the counter 445. The applet 440 can generate a MAC with the MAC session key over the counter, the unique customer identifier (pUID) 450, shared secret, and/or an applet version number of the applet 440. The applet 440 can encrypt the MAC with the ENC session key to generate a cryptogram. The applet 440 can transmit the applet version number, pUID, counter and encrypted MAC (the cryptogram) to the first device 110 or the user device 120. It is understood that comparable operations can be performed upon receipt of the cryptogram. In some embodiments, the server 130 can validate a cryptogram as follows. The server 130 can generate card UDKs using the pUID and bin level master keys (e.g., one for encryption (ENC) and one for message authentication code (MAC)), generate session keys from the UDKs and counter (e.g., one for encryption (ENC) and one for message authentication code (MAC)), decrypt the MAC from the cryptogram using the encryption session key, and validate the MA over the same info (pUID, counter, shared secret) using the MAC session key.

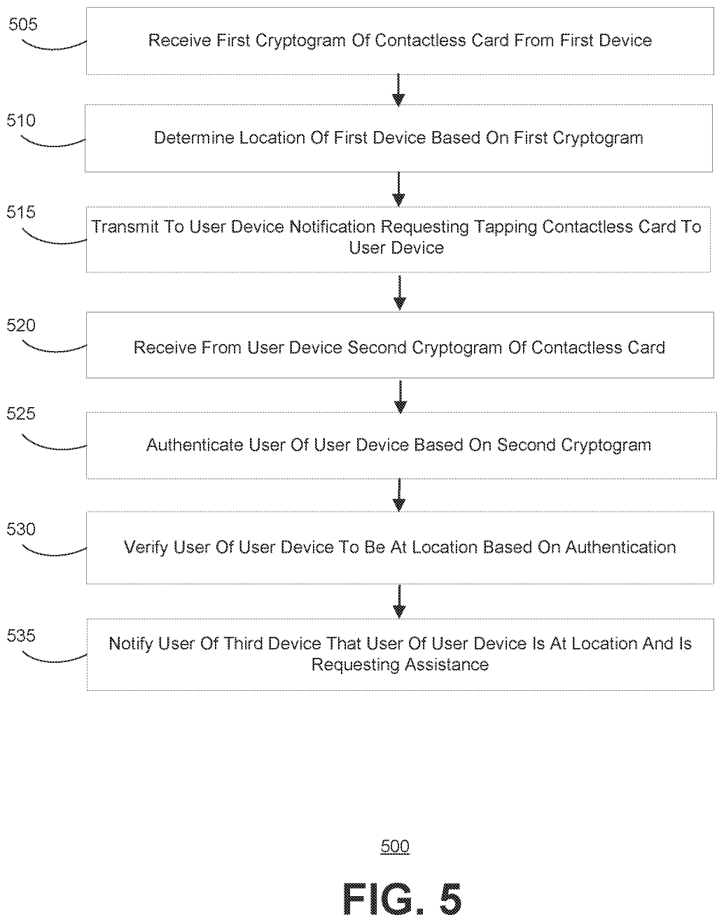

FIG. 5 illustrates a flow chart of an example method 500 for location-based check-in and assistance using a contactless card according to an example embodiment. FIG. 5 may reference the same or similar components as those illustrated in FIGS. 1-4, including a first device, a user device, a server, a database, and a contactless card. The method 500 can be implemented in the system 100 and may include, but is not limited to the following steps.

As described above, when a user wants to conduct businesses with a bank or a customer service center, for example, depositing a check at a bank branch or returning a product at a customer service desk, the user may walk into the bank branch. To check in, the user may use a contactless card (e.g., the contactless card 160) and a first device (e.g., the first device 110) such as a self-service kiosk at the bank branch. The first device 110 is a NFC-enabled device, and may include an NFC interface configured for establishing an NFC communication with other NFC-equipped devices (e.g., the contactless card 160). In some of these embodiments, the NFC interface of the first device 110 may be or include an NFC receiver configured for selectively activating a magnetic field for use in establishing near field communication with an NFC transmitter. The NFC interface of the first device 110 is configured for establishing NFC communication when a passive NFC tag or other NFC-enabled device is brought into the magnetic field and within the NFC communication range of the first device 110. The NFC interface of the first device 110 is configured, in particular, for communication with the NFC-enabled card 160 when the card 160 is brought within communication range of the first device (such as, the contactless card 160 is tapped by the user to the first device 110). As used herein, a tap of the contactless card 160 to the first device 110 may not indicate that the contactless card 160 is in a physical contact with the first device 110. A tap of the contactless card 160 to the first device 110 may refer to entry of the contactless card 160 into the NFC communication field of the first device 110. The contactless card 160 is also a NFC-enabled card. The first device 110 may transmit a first NFC query to the contactless card 160.

In response, after entry of the contactless card 160 into the NFC communication field of the first device, the contactless card 160 transmits to the first device 110 NFC response information (e.g., a first cryptogram) usable by the server 130 to authenticate the contactless card 160. The NFC response information may be or include, for example, security information encrypted by the contactless card 160 using a private key unique to the contactless card 160 that is known only to the card account administrator (e.g., the server 130). The first cryptogram may be stored in the memory of the contactless card 160. The first cryptogram includes an unique identifier of the contactless card 160.

The first device 110 transmits the first cryptogram to the server 130. At step 505, the server 130 receives the first cryptogram of the contactless card 160 from the first device 110. The server 130 validates the first cryptogram, decrypts the first cryptogram and extracts the unique identifier of the contactless card 160 through the card authentication module of the server 130. When the server 130 receives the first cryptogram, the server 130 may decrypt the cryptogram before or after verifying the first cryptogram. The server 130 may then extract the unique identifier of the contactless card 160 which is uniquely associated with the contactless card 160. At step 510, the server 130 then determines the location of the first device 110 based on the first cryptogram. The server 130 and/or the first device 110 may then notify employees at the bank branch that a customer has checked in using the contactless card 160. In this way, the bank employees know the user has arrived at the bank branch, that is, the user's location is known without physical contact/interaction with the bank employees.

The tap of the contactless card 160 on the first device 110 would notify the branch employees that the user is now at that specific branch location. However, the user may need to be further authenticated, that is, along with the geographical location of the bank branch, the user may be authenticated to insure that the user is who you say you are and you are where you say you are. For example, to authenticate the user, it may require the user to demonstrate that his/her mobile phone (e.g., the user device 120) and the contactless card 160 are in the same place (e.g., the branch location as determined above). At step 515, the server 130 may access the database 140 to retrieve data of the user device 120 and transmit a notification to the user device 120 to request the user to tap the contactless card 160 on the user device 120. The notification may be a short message service (SMS) message. The SMS message may contain a universal link (e.g., a deep link or application clip). The universal link in the SMS message may then open up a mobile application or mobile application process on the user device 120 from which the contactless card 160 can be read in that mobile application. If the mobile application is not already installed on the user device 120, the link may trigger a download activation to download the mobile application and install it on the user device 120. The user may use the user device 120 to transmit an NFC prompt and/or query to the contactless card 160. The user device 120 may include an NFC interface configured for establishing an NFC communication with other NFC-equipped devices (e.g., the contactless card 160). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the contactless card 160 transmits to the user device 120 NFC response information (e.g., a second cryptogram) usable by the server 130 to authenticate the user and/or contactless card 160. The NFC response information may be or include, for example, security information encrypted by the contactless card 160 using a private key unique to the card that is known only to the card account administrator (e.g., the server 130). The second cryptogram may be stored in the memory of the contactless card 160. The second cryptogram includes the unique identifier of the contactless card 160.

The user device 120 transmits the NFC response information (the second cryptogram) to the server 130. At step 520, the server 130 receives the second cryptogram from the user device 120. At step 525, the server 130 validates the second cryptogram, decrypts the second cryptogram and extracts the unique identifier of the contactless card 160 through the card authentication module of the server 130, and authenticate the user based on the second cryptogram. When the server 130 receives the second cryptogram, the server 130 may decrypt the second cryptogram before or after verifying the second cryptogram. The server 130 may then extract the unique identifier of the contactless card 160 which is uniquely associated with the user. The server 130 may verify the unique identifier of the contactless card 160 by searching the database 140. The user can be authenticated based on the unique identifier. At step 530, the server 130 may verify the user of the user device 120 to be at the location of the bank branch based on the authentication.

At step 535, the server 130 may notify the bank employees via one or more third devices that the user is at the bank location, authenticated and requesting assistance. The one or more third devices may be one or more computers used by the bank employees. Alternatively, the server 130 may also notify the bank employees through the first device 110 that the user has been authenticated, is at the bank location and is requesting assistance. For example, the server 130 may transmit a SMS message including the user's success authentication information to the bank employees via the one or more third devices, the first device 110 and/or other bank first devices. In this way, the user can be authenticated without contact/interactions with the bank employees, so no physical government ID of the user is required to exchange between the user and the bank employees for authenticating the user.

In some embodiments, the link with a deep link may be transmitted into the mobile application of the user device 120, and the user can follow the link to tap the contactless card 160. In such scenarios, the user does not have to fully log in the mobile application installed on the user device 120. The user just taps the contactless card 160 to the user device 120 and the server 130 verifies the user using the contactless card 160.

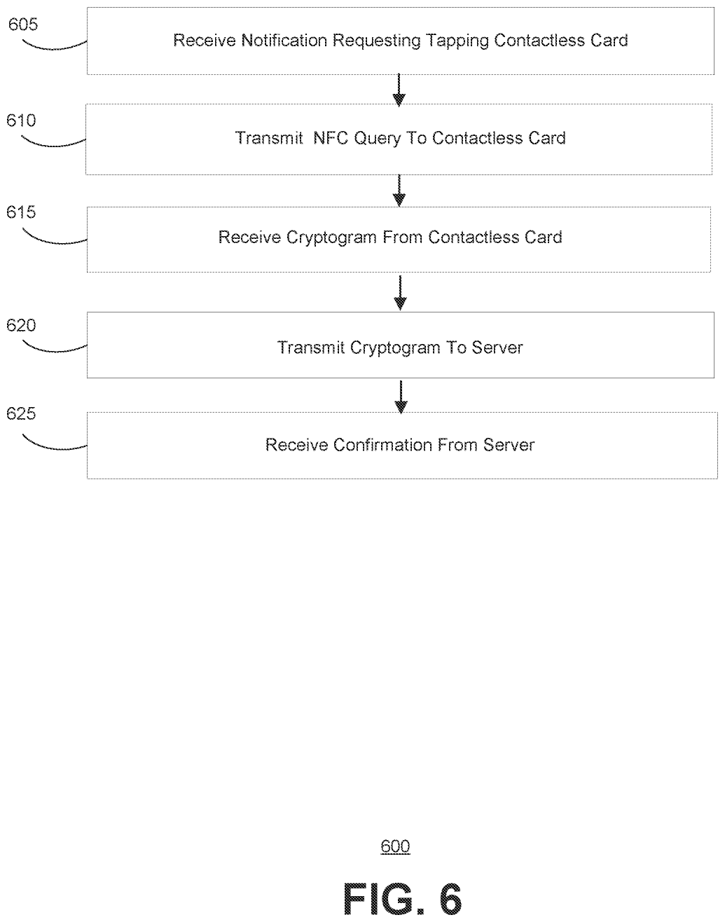

FIG. 6 illustrates a flow chart of an example method 600 for location-based check-in and assistance using a contactless card according to an example embodiment. FIG. 6 may reference the same or similar components as those illustrated in FIGS. 1-5, including a user device, a server, a database, a first device, and a contactless card. The method 600 can be implemented in the system 100 and may include, but is not limited to the following steps.

As described above, the tap of the contactless card 160 on the first device 110 would notify the branch employees that the user is now at that specific branch location. However, the user may need to be further authenticated, that is, along with the geographical location of the bank branch, the user may be authenticated. For example, to authenticate the user, it may require the user to demonstrate that his/her mobile phone (e.g., the user device 120) and the contactless card 160 are in the same place (e.g., the branch location as determined above). At step 605, the user device 120 may receive from the server 130 a notification requesting the user to tap the contactless card 160 on the user device 120. The notification may be a short message service (SMS) message. The SMS message may contain a universal link (e.g., a deep link or application clip). The universal link in the SMS message may then open up a mobile application or mobile application process on the user device 120 from which the contactless card 160 can be read in that mobile application. If the mobile application is not already installed on the user device 120, the link may trigger a download activation to download the mobile application and install it on the user device 120. At step 610, the user may use the user device 120 to transmit an NFC prompt and/or query to the contactless card 160, for example, by clicking on the link in the SMS message. The user device 120 may include an NFC interface configured for establishing an NFC communication with other NFC-equipped devices (e.g., the contactless card 160). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the contactless card 160 transmits to the user device 120 NFC response information (e.g., a cryptogram) usable by the server 130 to authenticate the user and/or contactless card 160. The NFC response information may be or include, for example, security information encrypted by the contactless card 160 using a private key unique to the card that is known only to the card account administrator (e.g., the server 130). The cryptogram may be stored in the memory of the contactless card 160. The cryptogram includes the unique identifier of the contactless card 160. Accordingly, at step 615, the user device 120 receive the cryptogram from the contactless card 160.

At step 620, the user device 120 transmits the cryptogram to the server 130. The server 130 receives the cryptogram and validates the cryptogram. The server 130 may further decrypt the cryptogram and extract the unique identifier of the contactless card 160 through the card authentication module of the server 130. The server 130 may decrypt the cryptogram before or after verifying the cryptogram. The server 130 may verify the unique identifier of the contactless card 160 by searching the database 140. The user can be authenticated based on the cryptogram and/or the unique identifier.

After authenticating the user, the server 130 may transmit a SMS message including the user's success authentication information to the user device 120. Accordingly, the user device 120 receives the SMS message from the server 130 and the user knows he/she has been successfully authenticated. In this way, the user can be authenticated without contact/interactions with the bank employees, so no physical government ID of the user is required to exchange between the user and the bank employees for authenticating the user.

In some embodiments, the link with a deep link may be transmitted into the mobile application of the user device 120, and the user can follow the link to tap the contactless card 160. In such scenarios, the user does not have to fully log in the mobile application installed on the user device 120. The user just taps the contactless card 160 to the user device 120 and the server 130 verifies the user using the contactless card 160.

As described, in some aspects, the techniques described herein relate to a method for location-based check-in and assistance based on a contactless card, including: receiving, by a server from a first device, a first cryptogram of the contactless card; determining, by the server, a location of the first device based on the first cryptogram; transmitting, by the server to a user device, a notification requesting tapping the contactless card to the user device; receiving, by the server from the user device, a second cryptogram of the contactless card; authenticating, by the server, a user of the user device based on the second cryptogram, the user being associated with the contactless card; verifying, by the server, the user of the user device to be at the location based on the authentication; and notifying, by the server, a user of a third device that the user of the user device is at the location and is requesting assistance.

In some aspects, the techniques described herein relate to a method, wherein the first cryptogram is generated by the first device upon tapping the contactless card to the first device.

In some aspects, the techniques described herein relate to a method, wherein the first device is in data communication with the contactless card through a near field communication (NFC).

In some aspects, the techniques described herein relate to a method, wherein the first device and the contactless card are near field communication (NFC)-enabled.

In some aspects, the techniques described herein relate to a method, the method further includes: validating, by the server, the second cryptogram; extracting, by the server from the second cryptogram, a unique customer identifier associated with the user of the user device; and verifying, by the server, the unique customer identifier.

In some aspects, the techniques described herein relate to a method, wherein the notification includes a link, the user of the user device be prompted to tap the contactless card to the user device upon clicking on the link.

In some aspects, the techniques described herein relate to a method, wherein the contactless card includes a processor and a memory, the memory storing the second cryptogram that contains the unique customer identifier.

In some aspects, the techniques described herein relate to a system for location-based check-in and assistance based on a contactless card, including a server, the server configured to: receive, from a first device, a first cryptogram of the contactless card; determine a location of the first device based on the first cryptogram; transmit, to a user device, a notification requesting tapping the contactless card to the user device; receive, from the user device, a second cryptogram of the contactless card; authenticate, a user of the user device based on the second cryptogram, the user being associated with the contactless card; verify the user of the user device to be at the location based on the authentication; and notify a user of a third device that the user of the user device is at the location and is requesting assistance.

In some aspects, the techniques described herein relate to a system, wherein the first device is a self-service kiosk in a bank branch at the location.

In some aspects, the techniques described herein relate to a system, wherein the user device is a user mobile device.

In some aspects, the techniques described herein relate to a system, wherein the user of the third device is an employee in a bank branch at the location.

In some aspects, the techniques described herein relate to a system, further including the contactless card, wherein the contactless card includes a processor and a memory, the memory storing the first cryptogram.

In some aspects, the techniques described herein relate to a system, wherein the second cryptogram is generated by the user device upon tapping the contactless card to the user device.

In some aspects, the techniques described herein relate to a system, wherein the user device is in data communication with the contactless card through a near field communication (NFC).

In some aspects, the techniques described herein relate to a non-transitory, computer-readable medium including instructions for location-based check-in and assistance based on a contactless card that, when executed on a computer arrangement, perform actions including: receiving, from a first device, a first cryptogram of the contactless card; determining a location of the first device based on the first cryptogram; transmitting, to a user device, a notification requesting tapping the contactless card to the user device; receiving, from the user device, a second cryptogram of the contactless card; authenticating, a user of the user device based on the second cryptogram, the user being associated with the contactless card; verifying the user of the user device to be at the location based on the authentication; and notifying a user of a third device that the user of the user device is at the location and is requesting assistance.

In some aspects, the techniques described herein relate to a non-transitory, computer-readable medium, wherein the first device is a near field communication (NFC)-enabled device.

In some aspects, the techniques described herein relate to a non-transitory, computer-readable medium, wherein the user device is an NFC-enabled device.

In some aspects, the techniques described herein relate to a non-transitory, computer-readable medium, wherein the contactless card is an NFC-enabled card.

In some aspects, the techniques described herein relate to a non-transitory, computer-readable medium, wherein the contactless card is one of a credit card, a debit card, or a gift card.

In some aspects, the techniques described herein relate to a non-transitory, computer-readable medium, wherein the notification includes a link, the user of the user device be prompted to tap the contactless card to the user device upon clicking on the link.

Throughout the disclosure, the terms merchant and bank are used, and it is understood that the present disclosure is not limited to a particular merchant or bank or type of merchant or bank. Rather, the present disclosure includes any type of merchant, vendor, or other entity involved in activities where products or services are sold or otherwise provided.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for location-based check-in and assistance based on a contactless card, comprising:
receiving, by a server from a first device, a first cryptogram of the contactless card;
determining, by the server, a location of the first device based on the first cryptogram;
transmitting, by the server to a user device, a notification requesting tapping the contactless card to the user device;
receiving, by the server from the user device, a second cryptogram of the contactless card;
authenticating, by the server, a user of the user device based on the second cryptogram, the user being associated with the contactless card;
verifying, by the server, the user of the user device to be at the location based on the authentication; and
notifying, by the server, a user of a second device that the user of the user device is at the location and is requesting assistance.

2. The method according to claim 1, wherein the first cryptogram is generated by the first device upon tapping the contactless card to the first device.

3. The method according to claim 2, wherein the first device is in data communication with the contactless card through a near field communication (NFC).

4. The method according to claim 1, wherein the first device and the contactless card are near field communication (NFC)-enabled.

5. The method according to claim 1, the method further comprises:
validating, by the server, the second cryptogram;
extracting, by the server from the second cryptogram, a unique customer identifier associated with the user of the user device; and
verifying, by the server, the unique customer identifier.

6. The method according to claim 1, wherein the notification includes a link, the user of the user device be prompted to tap the contactless card to the user device upon clicking on the link.

7. The method according to claim 1, wherein the contactless card comprises a processor and a memory, the memory storing the second cryptogram that contains an unique customer identifier.

8. A system for location-based check-in and assistance based on a contactless card, comprising a server, the server configured to:
receive, from a first device, a first cryptogram of the contactless card;
determine a location of the first device based on the first cryptogram;
transmit, to a user device, a notification requesting tapping the contactless card to the user device;
receive, from the user device, a second cryptogram of the contactless card;
authenticate, a user of the user device based on the second cryptogram, the user being associated with the contactless card; verify the user of the user device to be at the location based on the authentication; and
notify a user of a second device that the user of the user device is at the location and is requesting assistance.

9. The system according to claim 8, wherein the first device is a self-service kiosk in a bank branch at the location.

10. The system according to claim 8, wherein the user device is a user mobile device.

11. The system according to claim 8, wherein the user of the second device is an employee in a bank branch at the location.

12. The system according to claim 8, further comprising the contactless card, wherein the contactless card comprises a processor and a memory, the memory storing the first cryptogram.

13. The system according to claim 8, wherein the second cryptogram is generated by the user device upon tapping the contactless card to the user device.

14. The system according to claim 8, wherein the user device is in data communication with the contactless card through a near field communication (NFC).

15. A non-transitory, computer-readable medium comprising instructions for location-based check-in and assistance based on a contactless card that, when executed on a computer arrangement, perform actions comprising:
receiving, from a first device, a first cryptogram of the contactless card;
determining a location of the first device based on the first cryptogram;
transmitting, to a user device, a notification requesting tapping the contactless card to the user device;
receiving, from the user device, a second cryptogram of the contactless card;
authenticating, a user of the user device based on the second cryptogram, the user being associated with the contactless card;
verifying the user of the user device to be at the location based on the authentication; and
notifying a user of a second device that the user of the user device is at the location and is requesting assistance.

16. The non-transitory, computer-readable medium according to claim 15, wherein the first device is a near field communication (NFC)-enabled device.

17. The non-transitory, computer-readable medium according to claim 15, wherein the user device is an NFC-enabled device.

18. The non-transitory, computer-readable medium according to claim 15, wherein the contactless card is an NFC-enabled card.

19. The non-transitory, computer-readable medium according to claim 15, wherein the contactless card is one of a credit card, a debit card, or a gift card.

20. The non-transitory, computer-readable medium according to claim 15, wherein the notification includes a link, the user of the user device be prompted to tap the contactless card to the user device upon clicking on the link.
